(19) United States
(12) Patent Application Publication
(10) Pub. No.: US 2015/0363482 A1
(43) Pub. Date: Dec. 17, 2015

(54) METHOD OF VISUALLY REPRESENTING REPEATING DATA SETS

(71) Applicant: Daniel McAloon, Drexel Hill, PA (US)

(72) Inventor: Daniel McAloon, Drexel Hill, PA (US)

(21) Appl. No.: 14/303,916

(22) Filed: Jun. 13, 2014

(51) Int. Cl. G06F 17/30; G06T 11/00; G06T 11/20

(52) U.S. Cl. CPC G06F 17/30601; G06T 11/206; G06T 11/001

(57) ABSTRACT

A method of displaying repeating data with improved intelligibility includes identifying sequential and non-sequential data in a data collection. The method further includes assigning data categories from the sequential data. The method further includes determining frequency of non-sequential data elements via software executing on a computer. The method further includes identifying affiliations between the non-sequential data elements and the data categories via software executing on a computer. The method further includes displaying the data categories on a chart in positions based on their sequential order via software executing on a computer. The method further includes displaying the non-sequential data elements on the chart in positions based on their affiliation with the data categories via software executing on a computer. The method further includes displaying a visual indicium of the frequency of each of the data elements via software executing on a computer.

### TECHNICAL FIELD

The method described herein relates to the field of data processing, more particularly, to the field of visually representing data.

### BACKGROUND

Certain data sets have significant repetition of data, but are non-numeric. These data sets traditionally cannot be represented graphically without the use of stacked histograms. Histograms quickly get very unwieldy when more than a handful are used. Moreover, frequency analysis does not give a full picture of the data set and its trends. As a result, an analyst cannot glean trends from the data without rigorous analysis. Furthermore, the analyst may never gain a nuanced and intuitive understanding of the data.

There is a need in the art for a method of displaying sequential data in a simple, intuitive, yet detailed manner.

### BRIEF SUMMARY

A method of displaying repeating data with improved intelligibility includes identifying sequential and non-sequential data in a data collection. The method further includes assigning data categories from the sequential data. The method further includes determining frequency of non-sequential data elements via software executing on a computer. The method further includes identifying affiliations between the non-sequential data elements and the data categories via software executing on a computer. The method further includes displaying the data categories on a chart in positions based on their sequential order via software executing on a computer. The method further includes displaying the non-sequential data elements on the chart in positions based on their affiliation with the data categories via software executing on a computer. The method further includes displaying a visual indicium of the frequency of each of the data elements via software executing on a computer.

In some embodiments, the method further includes positioning the non-sequential data elements closer to data categories to which they are affiliated. In some embodiments, the method further includes displaying the data categories along an outer perimeter of the chart and the non-sequential data elements within the outer perimeter of the chart. In some embodiments, the perimeter is circular. In some embodiments, the visual indicium is the color of the data element. In some embodiments, the visual indicium is the brightness of the data element. In some embodiments, the visual indicium is the size of the data element. In some embodiments, the visual indicium is the number of rays emanating from the data element. In some embodiments, the method further includes modifying the chart based on input from a user via software executing on a computer. In some embodiments, the data collection includes prose data and tabular data. In some embodiments, the positioning, appearance, and resolution of the data categories and data elements are set by the user. In some embodiments, the positioning and appearance of the visual indicia are set by the user. In some embodiments, the non-sequential data is non-numeric.

### BRIEF DESCRIPTION OF THE DRAWINGS

FIG. 1 is a block diagram of the method according to one embodiment.

FIG. 2 is a representation of a graphical output of software performing the embodiment of the method represented in FIG. 1.

### DETAILED DESCRIPTION

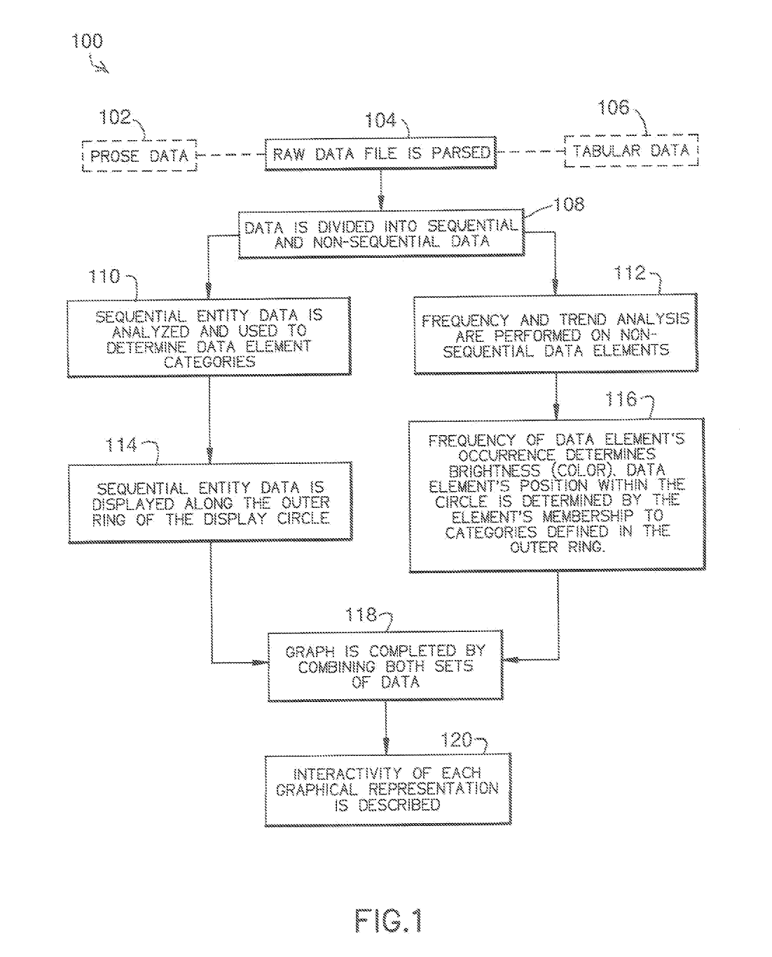

FIG. 1 is a block diagram of a method 100 according to one embodiment. In step 104, a raw data file containing prose data 102 and tabular data 106 is parsed. In some embodiments, data 102, 106 is analyzed first to determine if the data is suitable for this method (i.e. if it includes non-sequential and sequential data relating to each other). In some embodiments, data 102, 106 is transformed into data that is compatible with a parsing engine. In step 108, data 102,106 is divided into sequential and non-sequential data. In step 110, sequential data is analyzed and used to determine data element categories 210. In step 112, frequency and trend analysis are performed on non-sequential data elements 220. In some embodiments, this includes assigning frequency variables to the non-sequential data points and assigning the relationship between the non-sequential data and the sequential data categories.

In step 114, sequential entity data 210 is displayed along the outer ring of the display circle, in this embodiment. In step 116, frequency of the data elements' 220 occurrence determine brightness (or color) 230—data elements' 220 position within the circle is determined by the elements' membership to the categories 210 defined in the outer ring, in this embodiment. In step 118, the graph 200 is completed by combining both sets of data. In step 120, the elements within graph 200 are rendered interactive for the user.

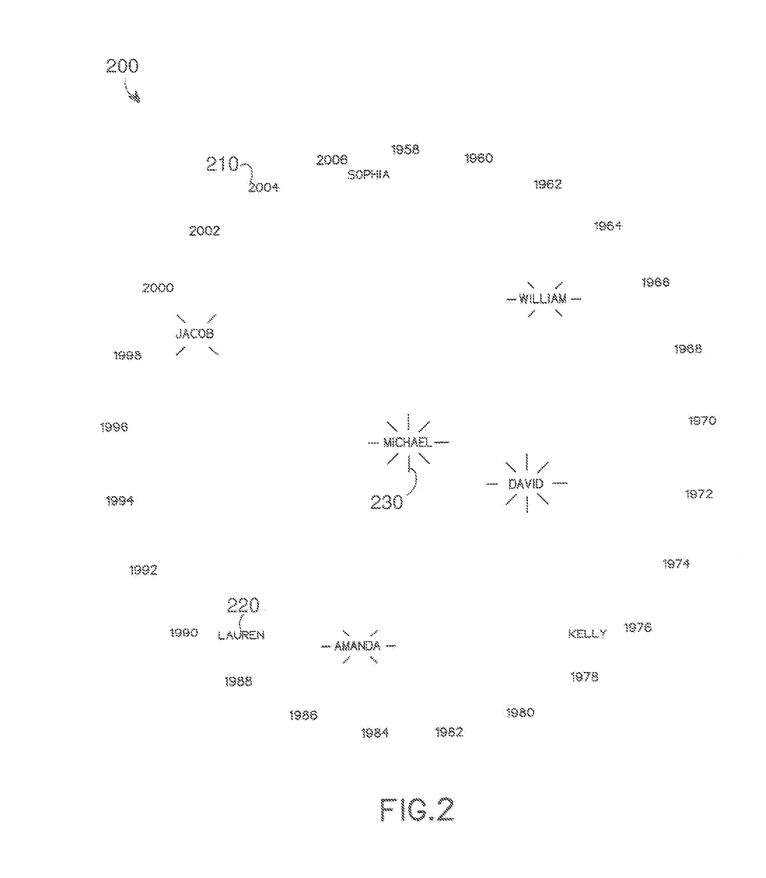

FIG. 2 is a representation of a graphical output 200 of software performing the embodiment of the method 100 represented in FIG. 1. In this example, the sequential data are years from 1958 to 2006 and the non-sequential data are the most popular names that year. Also in FIG. 2, the even years are displayed; however, the resolution of the categories 210 can be adjusted by the user or the software to improve legibility or conserve resources, regardless of the resolution within the data. In this embodiment, the data categories 210 of the sequential data are displayed sequentially in a circle around the outer perimeter of graph 200. However, in other embodiments, data categories 210 could be arranged in other two-dimensional shapes such as a square, or other dimensional shapes, such as a sphere or a line; and may also be arranged in alternative logical order rather than sequentially. In FIG. 2, the data set is “the most popular baby names of the last 50 years,” the header elements 210 are the years. In another example, if the data set were the complete work of the Bible, the header elements 210 could be the book and chapter numbers. In fact, the methods described herein can work for any sequential data set, including data over periods of time, paragraphs/chapters in a prose work, iterations of a book or movie series, items in a list, etc.

The non-sequential (and non-numeric in this embodiment) data elements 220 are graphically represented within the circle of data categories 210, in this embodiment. The position of data elements 220 with respect to data categories 210 is determined by the frequency in the specific categories. For example, “Kelly” was a popular name in 1976 and 1978 and unpopular in other years, so it is near 1976 and 1978 and far from all of the other data categories 210. “Michael” was a popular name for all of the years and is near the center of graph 200 (by being equally distant from all of the data categories 210). “Amanda” was popular during the 1980s, but not at other times—therefore, “Amanda” is equally close to the years in the 1980s and far from the other years. The frequency of data elements 220 in each category 210 is determined during the frequency and/or trend analysis stage of the method. A subset of the non-sequential data elements 220 may be selected by the user or the software for display within the graph 200, and certain elements 220 may be excluded for greater legibility, conservation of resources, or user preference.

The frequency of each data element 220 is graphically presented to the user by indicium 230. In this embodiment, indicium 230 is the number of rays emanating from each data element 220. However, indicium 230 could be any visible or otherwise perceptible indicium, such as brightness, boldness, size, or color. As can be seen in FIG. 2, “Michael” was popular in all years and also highly frequent in the data set, therefore “Michael” has eight rays surrounding it for its indicium 230. “Kelly” was infrequent in the data set, and features no rays for its indicium 230. “Amanda” has an intermediate frequency and has six rays for its indicium 230.

Graphical output 200 may be adjusted by the user either in advance of being rendered or after being rendered. The user may adjust the form of indicia 230, or arrangement, resolution, or appearance of categories 210 and elements 220. Furthermore, graphical output 200 is interactive in some embodiments, allowing on-the-fly micro-adjustments or manipulation of the graphical position for varied view of large data sets. In some embodiments, the elements 220 are displayed inside a translucent sphere of categories 210 that can be rotated by the user to view different portions of the data set. Moreover, the user can adjust the labels or appearance of categories 210 and elements 220 in real-time.

In some embodiments, the software implementing the method described herein is designed for third-party interactivity. Each step in the process is programmed to work in concert with the others, and the software is designed modularly so as to potentially source from and feed various other third-party systems. For instance, the data load step (step 104) can read from either prose data 102 or tabular data 106. The display and interactivity steps (114, 116, 118, and 120) can also be fed into or implemented on third-party systems.

The method and software described herein graphically represent large, repetitive, non-numeric data sets in a single view, without subjecting the user to the inconvenience of multiple stacked histograms. The method and software described herein represent the entire data set as a single interactive graphical view, simplifying analysis. This system discards the notion of stacked histograms and frequency analysis and instead presents the notion of a whole-data-set view representing frequency and trends in the same graphic. It is also interactive and immediately shows popular items, trends, and patterns in a single interactive view, without extensive analysis.

Although the invention has been described with reference to embodiments herein, those embodiments do not limit the invention. Modifications to those embodiments or other embodiments may fall within the scope of the invention.

What is claimed is:

1. A method of displaying repeating data with improved intelligibility, comprising:
(a) identifying sequential and non-sequential data in a data collection;
(b) assigning data categories from the sequential data;
(c) determining frequency of non-sequential data elements via software executing on a computer;
(d) identifying affiliations between the non-sequential data elements and the data categories via software executing on a computer;
(e) displaying the data categories on a chart in positions based on their sequential order via software executing on a computer;
(f) displaying the non-sequential data elements on the chart in positions based on their affiliation with the data categories via software executing on a computer; and
(g) displaying a visual indicium of the frequency of each of the data elements via software executing on a computer.

2. The method of claim 1, wherein step (f) comprises positioning the non-sequential data elements closer to data categories to which they are affiliated.

3. The method of claim 1, wherein step (e) comprises displaying the data categories along an outer perimeter of the chart and step (f) comprises displaying the non-sequential data elements within the outer perimeter of the chart.

4. The method of claim 2, wherein the perimeter is circular.

5. The method of claim 1, wherein the visual indicium is the color of the data element.

6. The method of claim 1, wherein the visual indicium is the brightness of the data element.

7. The method of claim 1, wherein the visual indicium is the size of the data element.

8. The method of claim 1, wherein the visual indicium is the number of rays emanating from the data element.

9. The method of claim 1, further comprising:
(h) modifying the chart based on input from a user via software executing on a computer.

10. The method of claim 1, wherein the data collection comprises prose data and tabular data.

11. The method of claim 1, wherein the positioning, appearance, and resolution of the data categories and data elements are set by the user.

12. The method of claim 1, wherein the positioning and appearance of the visual indicia are set by the user.

13. The method of claim 1, wherein the non-sequential data is non-numeric.
